(19) United States
(12) Patent Application Publication
(10) Pub. No.: US 2026/0269212 A1
(43) Pub. Date: Sep. 10, 2026

(54) PATTERNED ELECTRODE FOR A METAL-HYDROGEN BATTERY

(71) Applicant: EnerVenue Holdings, Ltd., Fremont, CA (US)

(72) Inventors: Jun Li, Fremont, CA (US); Ge Zu, Fremont, CA (US); Hung-Ming Wang, Fremont, CA (US); Nelson Dichter, Fremont, CA (US); Majid Keshavarz, Fremont, CA (US)

(21) Appl. No.: 19/560,562

(22) Filed: Mar. 9, 2026

Related U.S. Application Data
(60) Provisional application No. 63/769,590, filed on Mar. 10, 2025.

(51) Int. Cl. H01M 4/04; H01M 4/02

(52) U.S. Cl. CPC H01M 4/0435; H01M 2004/021

(57) ABSTRACT

In accordance with embodiments of the present disclosure, an anode is presented. The anode includes a first anode material, the first anode material having a flat side and an embossed side that is embossed with a first embossing pattern; and a second anode material, the second anode material having a flat side and an embossed side that is embossed with a second embossing pattern, wherein the embossed side of the first anode material is positioned against the embossed side of the second anode material, and wherein the first anode material and the second anode material are coupled on one edge.

### RELATED APPLICATIONS

This disclosure claims priority to U.S. Provisional Application 63/769,590, filed on Mar. 10, 2025, which is herein incorporated by reference in its entirety.

### TECHNICAL FIELD

This disclosure is generally related to debossing anodes used in a metal-hydrogen battery, and more particularly to advantageous debossing patterns in an anode of a metal-hydrogen battery.

### BACKGROUND

For renewable energy resources such as wind and solar to be competitive with traditional fossil fuels, large-scale energy storage systems are needed to mitigate their intrinsic intermittency. To build large-scale energy storage, the cost and long lifetime are the utmost considerations. Currently, pumped-hydroelectric storage dominates the grid energy storage market because it is an inexpensive way to store large quantities of energy over a long period of time (about 50 years), but it is constrained by the lack of suitable sites and the environmental footprint. Other technologies such as compressed air and flywheel energy storage show some different advantages, but their relatively low efficiency and high cost should be significantly improved for grid-scale storage. Rechargeable batteries offer great opportunities to target low-cost, high-capacity and highly reliable systems for large-scale energy storage. Improving the reliability of rechargeable batteries and reducing their cost have become critical challenges to realize large-scale energy storage.

One of the major contributors to the cost of producing metal-hydrogen batteries is the cost of the electrodes, i.e. cathode and anode. Consequently, there is an interest in optimizing the performance of the electrodes, especially the anode.

Therefore, there is a need for producing long lasting anodes with higher efficiency for a metal-hydrogen battery structure.

### SUMMARY

In accordance with embodiments of the present disclosure, an anode is presented. The anode includes a first anode material, the first anode material having a flat side and an embossed side that is embossed with a first embossing pattern; and a second anode material, the second anode material having a flat side and an embossed side that is embossed with a second embossing pattern, wherein the embossed side of the first anode material is positioned against the embossed side of the second anode material, and wherein the first anode material and the second anode material are coupled on one edge.

In some embodiments, the first embossing pattern and the second embossing pattern are each a mesh pattern. Consequently, the first embossing pattern and the second embossing pattern are formed with a press. In some embodiments, the press includes a wire mesh. In some embodiments, the press includes a perforated metallic pattern.

In some embodiments, the first embossing pattern and the second embossing pattern are formed with a roller press. In some embodiments, the roller press includes a first roller with an embossing pattern and a second roller with a smooth surface. In some embodiments, the embossing pattern is a downweb pattern. In some embodiments, embossing pattern is an angular pattern, which may have a 45-degree pattern. In some embodiments of the angular pattern, the first anode material and the second anode material are stacked such that the angular pattern of the first embossing pattern and the angular pattern of the second embossing pattern are crossed. In some embodiments, the embossing pattern is a chevron pattern. In some embodiments of the chevron pattern, the first anode material and the second anode material are stacked such that the chevron pattern of the first embossing pattern points to a first edge and the chevron pattern of the second embossing pattern points to the edge opposite the first edge.

In some embodiments, the one edge is a tab. In some embodiments, the one edge is a metal sheet.

In some embodiments, a method of forming an anode is presented. In some embodiments, the method includes preparing an anode material sheet; imprinting an embossing pattern on the anode material sheet; forming anode material from the embossed anode material sheet; placing two anode materials together with the embossing pattern of each of the anode materials facing each other; and welding the two anode materials together along one edge. In some embodiments, the anode material includes a Ni-Foam coated with a catalyst.

In some embodiments, imprinting the embossing pattern includes pressing the embossing pattern with a press into the anode material sheet. In some embodiments, the press is a wire mesh. In some embodiments, the press is a protrusion mesh.

In some embodiments, imprinting the embossing pattern includes placing the anode material sheet through a rolling press with an embossing pattern. In some embodiments, the embossing pattern is a downweb pattern. In some embodiments, the embossing pattern is an angled pattern. In some embodiments, the embossing pattern is a chevron pattern.

Other embodiments are contemplated and explained herein after.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the disclosure are utilized, and the accompanying drawings of which:

FIGS. 1A and 1B depict an individual pressure vessel (IPV) that has been previously disclosed.

FIG. 2 illustrates a bridgeless CPV superstack according to embodiments of the present disclosure.

FIGS. 3A, 3B, 3C, and 3D illustrate components of the bridgeless CPV superstack illustrated in FIG. 2.

FIG. 4 illustrates a two-layer anode according to some embodiments.

FIGS. 5A and 5B illustrates an example of anode material with a corrugated debossing pattern.

FIGS. 6A through 6G illustrate examples of anode materials with mesh debossing patterns according to some embodiments of the present disclosure.

FIGS. 7A through 7B illustrate formation of a two-layer anode using the anode materials illustrated in FIGS. 6A through 6G according to some embodiments of the present disclosure.

FIGS. 8A through 8E illustrates examples of production of a downweb embossing pattern according to some embodiments of the present disclosure.

FIGS. 9A through 9C illustrate a rolling press for formation of an angular embossing pattern according to some embodiments of the present disclosure.

FIGS. 10A through 10D illustrate formation of an anode material using the rolling press illustrated in FIGS. 9A through 9C according to some embodiments of the present disclosure.

FIGS. 11A through 11F illustrate formation of an anode material having a chevron embossing pattern according to some embodiments of the present disclosure.

FIG. 12 illustrates a method of forming an embossed pattern according to some embodiments of the present disclosure.

### DETAILED DESCRIPTION OF EMBODIMENTS

In the following description, certain specific details are set forth in order to provide a thorough understanding of various embodiments of the disclosure. However, one skilled in the art will understand that the disclosure may be practiced without these details. Moreover, while various embodiments of the disclosure are disclosed herein, many adaptations and modifications may be made within the scope of the disclosure in accordance with the common general knowledge of those skilled in this art. Such modifications include the substitution of known equivalents for any aspect of the disclosure in order to achieve the same result in substantially the same way.

Unless the context requires otherwise, throughout the present specification and claims, the word “comprise” and variations thereof, such as, “comprises” and “comprising” are to be construed in an open, inclusive sense, that is as “including but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

Terms such as “top,” bottom”, “left”, “right”, “over”, “under” or other directional references are relative to the figure and are not intended to be absolute. These references should be interpreted as relative to the figure being discussed and are not intended to be limiting.

Metal-hydrogen batteries can be configured in a number of ways. In each case, the battery itself includes one or more electrode stacks, each with a series of electrodes (alternating layers of cathode material and anode material) separated by electrically isolating separators. The electrode stacks, which are saturated with electrolyte, are housed in one or more pressure vessels. The electrode stacks can provide arrays of cells (i.e., pairs of cathode and anode electrodes) that can be electrically coupled in series or in parallel. Each electrode stack can be arranged such that the cells formed in the array of electrodes are coupled in parallel. In accordance with embodiments of the present disclosure, an electrode stack that is formed by a stacked arrangement of serially coupled components, housed in a common pressure vessel (CPV) can be produced.

As discussed above, the electrode stack is formed by alternating anode and cathode electrodes separated by insulating layers. Typically, all of the cathode electrodes in the stack are electrically coupled and all of the anode electrodes in the stack are electrically coupled to form the battery. In embodiments of the present disclosure, the anode electrodes are formed with an embossed anode material that allows hydrogen transport between layers of anode material that form each of the anode electrodes.

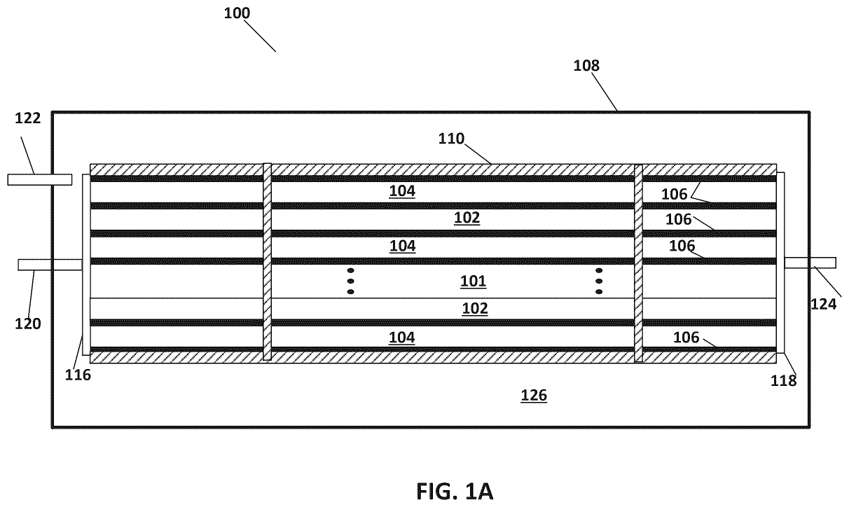

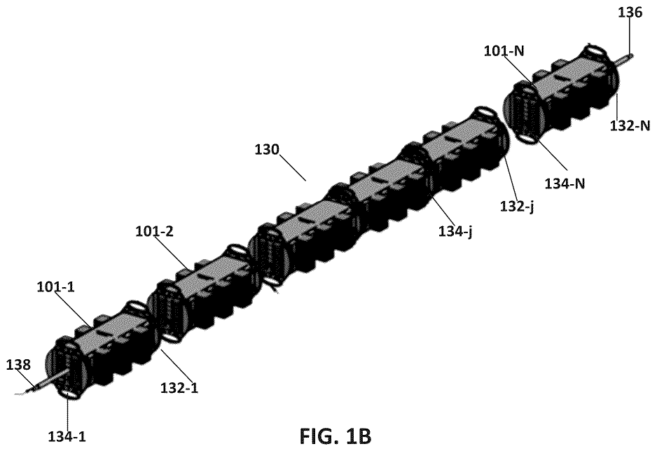

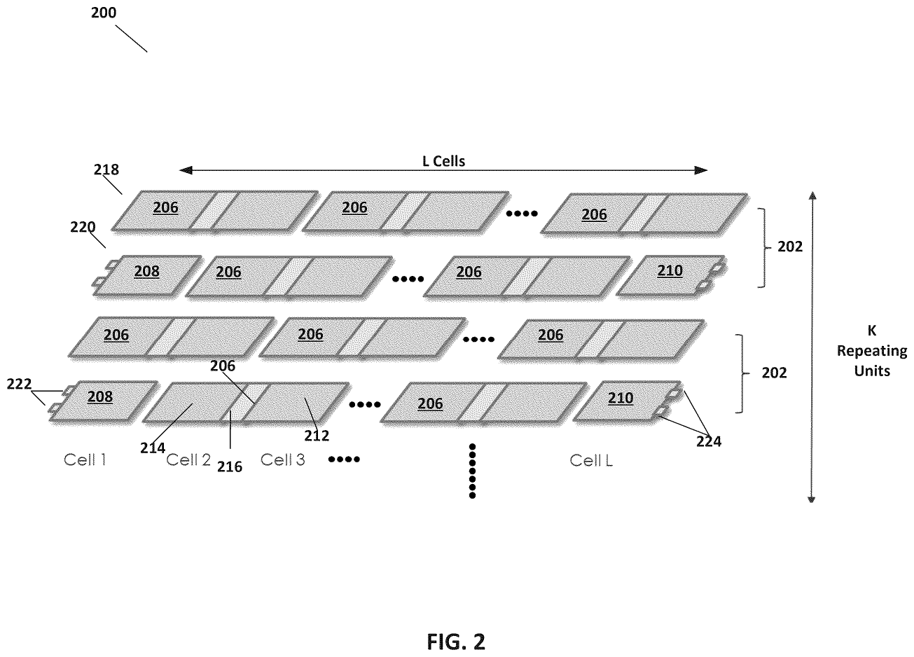

A common pressure vessel (CPV) as described here is a large format battery, where multiple electrode stacks connected in series or parallel, or both, are enclosed in a common pressure vessel. Compared to an individual pressure vessel (IPV) as illustrated in FIG. 1A, or collection of IPVs with the same energy capacity, a CPV has fewer parts (end caps, feedthroughs, fill ports, busbars, wires, BMS etc.), fewer welds and exhibits lower weight and cost. Series coupling the stacks illustrated in FIG. 1A below with inter-stack bridge connections can be used in a battery, as is illustrated in FIG. 1B. However, other embodiments, as is illustrated in FIGS. 2A and 2B, illustrate a stack that is formed of a combination of series and parallel oriented anode/cathode combinations that eliminate the need for inter-stack bridge connections, which further reduces the weight and the materials used in producing the battery, simplifying super stack production and enhancing the performance at the same time. However, both styles of battery can benefit from anodes according to embodiments as discussed below.

FIGS. 1A and 1B illustrate a configuration of an IPV and previous CPV, which is based on IPV, that as has been previously presented in U.S. patent application Ser. No. 17/898,098, filed on Aug. 29, 2022, entitled “Nickel-Hydrogen Battery Configurations for Grid-Scale Energy Storage,” which is herein incorporated by reference in its entirety. FIGS. 2A and 2B illustrate batteries as described in U.S. patent application Ser. No. 18/987,378, entitled “Nickel-Hydrogen Battery Configurations for Grid-Scale Energy Storage,” filed on Dec. 19, 2024, which is also herein incorporated by reference in its entirety.

FIG. 1A depicts a schematic depiction of an individual pressure vessel (IPV) metal-hydrogen battery 100. The metal-hydrogen battery 100 includes electrode stack assembly 101 that includes stacked electrodes separated by separators 106. The electrodes include cathodes 102 and anodes 104. Separator 106 is positioned between the cathode 102 and the anode 104. Each pair of cathode 102 and anode 104 electrodes can be considered a cell, or an electrical source. The electrode stack 101 can further include a frame 110 that fixes the cathodes 102, anodes 104, and separators 106 in place. In the particular example illustrated in FIG. 1A, there is an anode 104 on both the top and bottom of stack 101, adjacent to frame 106, however other arrangements can also be formed.

The electrode stack 101 can be housed in a pressure vessel 108. Pressure vessel 108 can contain electrolyte 126 and hydrogen gas. The cathode 102, the anode 104, and the separator 106 are porous to allow electrolyte 126 to flow between the cathode 102 and the anode 104. Electrode stack 101 is saturated with electrolyte 126. The metal-hydrogen battery 100 can further include a fill tube 122 configured to exchange electrolyte or gases (e.g., hydrogen gas) with pressure vessel 108.

As shown in FIG. 1A, electrode stack 101 includes a number of stacked layers of alternating cathode 102 and anode 104 separated by a separator 106 in an individual pressure vessel (IPV). Stack 101 includes at least one pair of cathode 102 and anode 104. Cells can be formed by pairs of cathode 102 and anode 104 layers. Although the cells in an electrode stack assembly 101 may be coupled either in parallel or in series, in the example of battery 100 illustrated in FIG. 1A the cells are coupled in parallel. In particular, each cathode 102 is coupled to a bridge conductor 118 and each anode 104 is coupled to a bridge conductor 116. Although FIG. 1A illustrates that fill tube 122 is positioned on the side of anode bridge conductor 116, it may alternatively be placed on the side of cathode bridge conductor 118, or in the side wall of pressure vessel 108. Fill tube 122 may include one or more valves (not shown) or may be otherwise sealed after pressure vessel 108 is charged with operating levels of electrolyte 126.

Additionally, in the example of FIG. 1A, pressure vessel 108 is illustrated as a cylindrical vessel that contains a single electrode stack 101. In accordance with embodiments of the present disclosure, pressure vessel 108 can be of any shape large enough to contain multiple electrode stacks 101 and hold the pressures involved during operation. Further, in FIG. 1A electrode stack 101 is illustrated as being oriented along a length of pressure vessel 108. However, electrode stack 101 can be arranged so that the electrodes are laterally oriented instead. Consequently, electrode stack 101 can be in any shape, have any number of cells, and have any orientation relative to pressure vessel 108.

As is further illustrated in FIG. 1A, bridge conductor 116, which is coupled to anodes 104, is electrically coupled to an anode feedthrough terminal 120, which may present the negative terminal of battery 100. Terminal 120 can include an insulated feedthrough to allow terminal 120 to extend outside of pressure vessel 108, or bridge conductor 116 may be connected directly to pressure vessel 102. Similarly, cathode conductor 118, which is coupled to cathodes 102, can be coupled to a cathode feedthrough terminal 124 that represents the positive side of battery 100. Terminal 124 also passes through an insulated feedthrough to allow terminal 124 to extend to the outside of pressure vessel 108.

As discussed above, each cell included in electrode stack 101 includes a cathode 102 and an anode 104 that are separated by separators 106. The electrode stack 101 is positioned in pressure vessel 108 where electrolyte 126 can flow between cathode 102 and anode 104. As is discussed further below, cathode 102 is formed of a conductive substrate coated by a metal compound. Similarly, anode 104 is formed of a porous conductive substrate coated with a porous catalyst. Separator 106 is a porous insulator that can separate alternating layers of cathode 102 and anode 104 and allow electrolyte 126 to transport between cathode 102 and anode 104. In some embodiments, the electrolyte 126 is an aqueous electrolyte that is alkaline (with a pH greater than 7). Each anode 104 and cathode 102 can be formed as electrode assemblies with multi-layered structures.

FIG. 1A depicts a schematic of an IPV configuration metal-hydrogen battery 100 that includes an electrode stack 101. The electrode stack 101 includes at least one layer that includes a cathode 102, an anode 104, and a separator 106 disposed between the cathode 102 and the anode 104. The layer 101 is housed in an enclosure 108. Electrolyte 126 is disposed in the enclosure 108. The cathode 102, the anode 104, and the separator 106 are porous to allow the electrolyte 126 to communicate between the cathode 102 and the anode 104. The metal-hydrogen battery 100 pressure vessel 108 further includes a fill tube 122 configured to exchange hydrogen gas and electrode 126 with the interior of enclosure 108.

A configuration of battery layers that are all contained within a vessel is presented. As discussed further below, some embodiments can include Ni—H₂ cells that may include nickel-hydroxide cathode, an H₂-catalytic anode, and a porous separator saturated in 5% to 50% potassium hydroxide all sealed inside of a metal pressure vessel, although other configurations are possible as discussed above. The typical cell design contains many pairs of cathodes and anodes separated by the porous separators and each pair is connected in parallel, as is illustrated in FIG. 1A. This configuration is referred to as an individual pressure vessel, or IPV, design. The IPV design allows for high capacity but achieves only a 1.25 V nominal discharge voltage under typical conditions. The pressure vessel 108 is leak free and capable of withstanding pressure greater than 1000 psi, which is a major cost contributor for Ni—H₂ cells.

An embodiment of electrode stack 101 as illustrated above being used in an individual pressure vessel (IPV) configuration is described in more detail in U.S. patent application Ser. No. 17/830,193, entitled “Electrode Stack Assembly for a Metal Hydrogen Battery,” filed on Jun. 1, 2022, which is herein incorporated by reference. Another embodiment of electrode stack 101 is described in U.S. patent application Ser. No. 17/687,527, entitled “Electrode Stack Assembly for a Metal Hydrogen Battery,” filed on Mar. 4, 2022, which is also incorporated by reference in its entirety. An additional application directed to embodiments of electrode stack 101 is described in U.S. patent application Ser. No. 18/987,378, entitled “Nickel-Hydrogen Battery Configurations for Grid-Scale Energy Storage,” filed on Dec. 19, 2024, which is herein incorporated by reference in its entirety. These and other electrode stacks may be utilized in embodiments of this disclosure as described below.

A plurality of electrode stacks 101 as illustrated in FIG. 1A can be electrically coupled through bridges in series and housed in a CPV pressure vessel to form a CPV configuration battery. In particular, each of electrode stack 101 includes bridge conductors that are easily welded to corresponding bridge conductors of an adjacent electrode stack 101 when the stacks 101 have been aligned. These bridge conductors between adjacent stacks 101 work as bipolar plates (i.e. the anode bridge of one stack is connected to the cathode bridge of the adjacent stack). FIG. 1B illustrates a construction using a series coupled plurality of stacks 101.

FIG. 1B illustrates alignment of N electrode stacks 101 (electrode stacks 101-1 through 101-N) as described above with respect to FIG. 1A. As illustrated in FIG. 1B, electrode stacks 101-1 through 101-N are arranged to be coupled in series to form stack arrangement 130, with the anode of one of electrode stacks 101 being coupled to the cathode of an adjacent electrode stack 101 using bridge conductors 140. In the example illustrated in FIG. 1B, bridge 134-1 is coupled to a terminal rod 138. Bridge 132-N is coupled to a terminal rod 136.

Bridge conductor 140 can be configured to be electrically connected to either the anodes or the cathodes of electrode stack 101. Bridge conductor 140 can include, for example, a bridge frame that can be configured to mate with isolators that help isolate bridge conductor from other components of stack 101. Additionally, the bridge frame is configured to be mechanically connected (e.g., welded) to bridge frames of adjacent ones of electrode stacks 101 or to a terminal rod such as the terminal rods illustrated in FIG. 1B. Bridge conductor 140 can also include slots that are configured to accept tabs that are formed in the anodes or cathodes of stack 101. The tabs are inserted into the slots to form either bridge 134 or bridge 132 as illustrated in FIG. 1B.

As illustrated in FIG. 1B, the stack arrangement 130 can be formed by welding bridge conductors 134 to bridge conductors 132 to form a serial arrangement 130. Feedthrough conductors can be welded to bridge conductor 134-1 and to bridge conductor 132-N.

In some embodiments, the inter-stack connections 152 can be eliminated by building a bridgeless CPV superstack. Individual stacks 101 are not assembled, which eliminates the need for producing the inter-stack connections 152. Since, in this embodiment, the individual electrodes are directly joined together, the overall electrical resistance of the super stack is also much lower, which boosts the energy efficiency of a resulting battery using the bridgeless CPV superstack.

FIG. 2 illustrates a bridgeless CPV superstack 200 (also referred to as stack 200) according to some embodiments of the present disclosure. As illustrated in FIG. 2, bridgeless CPV superstack 200 is formed with combinations of three components: an intermediate anode-cathode 206, end anode 208, and end cathode 210. Intermediate anode-cathode 206 is formed by welding an anode 212 and a cathode 214 together through a metal sheet 216. In order to prevent electrolyte bridges, which can cause short circuits between electrodes, one or more of the following approaches can be used: 1) the metal sheet 216 between anode 212 and cathode 214 is made wide enough to prevent formation of electrolyte bridges; 2) plastic tapes can be applied to the metal sheet 216 to prevent formation of electrolyte bridges; and/or 3) the electrolyte quantity can be controlled to prevent formation of electrolyte bridges.

End anode 208 includes one or more layers of anode material welded to tabs 222. Tabs 222 can engage with slots of bridge conductor 140 as illustrated in FIG. 1B. Bridge conductor 140 can be connected to a feedthrough conductor which can engage with a feedthrough in the pressure vessel. Similarly, end cathode 210 includes a cathode material coupled to tabs 214, which can engage with slots of a bridge conductor 140. Again, bridge conductor 140 engaging with end cathode 210 can include a feedthrough conductor that engages with a feedthrough in the pressure vessel.

As illustrated in FIG. 2, bridgeless CPV superstack 200 can be formed in layers. A unit 202 can be formed with a first layer 218 that includes L/2 intermediate anode-cathodes 206 adjacently placed but separated by a space equivalent to the width of metal sheet 216. Second layer 220 has at one end an end anode 208 and the other an end cathode 210 with L/2-1 intermediate anode-cathodes 206 separating the end anode 208 and the end cathode 210. First layer 218 and second layer 220 are aligned such that a cathode in layer 218 is adjacent to an anode of layer 220 (e.g., end anode 208 is aligned with cathode 214 of an intermediate anode-cathode 206 and end cathode 210 is aligned with anode 212 of an intermediate anode-cathode 206) to form L cells in each of the K units. There can be K repeated units 202 that are stacked and aligned with one another in bridgeless CPV superstack 200. Four example batteries are further discussed below with example 1 having L=6 and K=20, example 2 having L=6 and K=30, example 3 having L=12 and K=25, and example 4 having L=12 and K=33. These examples are illustrated below with respect to Table 1 and some of their example characteristics.

As illustrated in FIG. 2, L can be any even number. Further, there may be any number K of units 202 stacked to form bridgeless CPV superstack 200. As a consequence, to form bridgeless CPV superstack 200, there are K end anodes 208, K end cathodes 210, and K*(L-1) intermediate anode-cathodes 206 in the assembly. If K=20 and L=6, for example, then there will be 20 end anodes 208, 20 end cathodes 210, and 100 intermediate anode-cathodes 206 arranged as shown in FIG. 2.

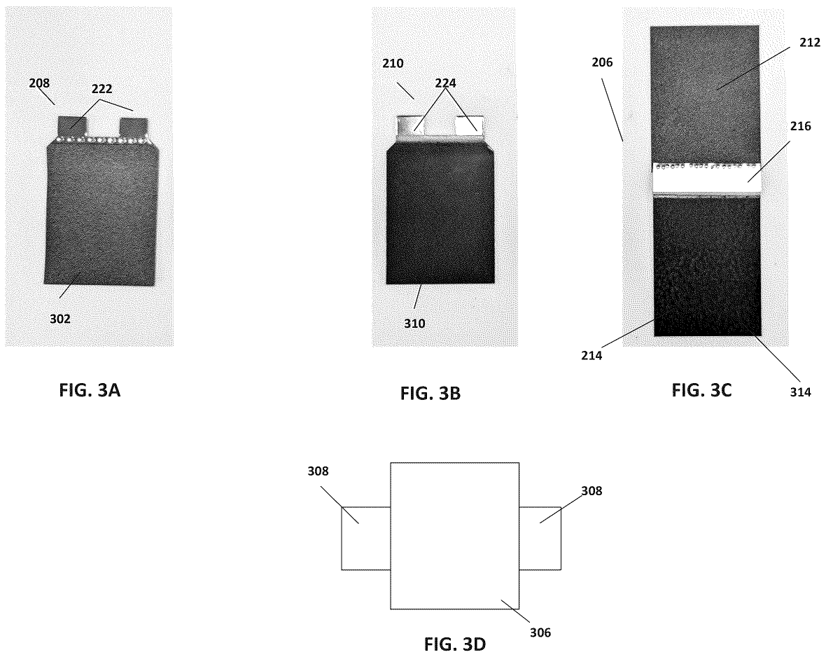

FIGS. 3A, 3B, 3C, and 3D illustrates various components of a first bridgeless CPV using superstack 200 according to some embodiments, although some of these components can also be used in stack 101 as illustrated in FIG. 1A. FIG. 3A illustrates an end anode 208. As illustrated, end anode 208 can be formed of multiple layers of anode material 302. In some embodiments, multiple layers 302 can include two layers of anode material, although three or more layers may also be used. Multiple layers 302 are welded to tabs 222. In some embodiments, tabs 222 may include a single tab or may include multiple tabs. As is illustrated, the resulting anode 208 is a rectangle having a long side and a short side, where the short side is welded to tabs 222.

FIG. 3B illustrates end cathode 210, which can be used in stack 200 or in stack 101. As illustrated in FIG. 3B, end cathode 210 includes cathode material 310 connected to tabs 224. Tabs 224 may include a single tab and may include multiple tabs. In some embodiments, cathode material 310 is encased in separator material. Further, the separator material includes wall wicks, which can help with aligning components during assembly as well as functioning to wick electrolyte from the sidewall of a pressure vessel in the finished battery. As is illustrated, end cathode 210 is also a rectangle having a long side and a short side, which is welded to tabs 224. In general, the size of end anode 208 and the size of end cathode 210 are the same.

FIG. 3C illustrates an intermediate anode-cathode 206, which is used in stack 200. As is illustrated and discussed above, intermediate anode-cathode 206 includes an anode 212 welded to a cathode 214 through a metal sheet 216. Anode 212 can include the multiple layers 302 as illustrated in FIG. 3A. Cathode 214 includes a cathode material 314, which can be encased in separator material that has wall wicks. Again, the wall wicks can be helpful in alignment as well as functioning to wick electrolyte from the sidewall of a pressure vessel.

FIG. 3D illustrates a separator pouch 306 according to some embodiments of the present disclosure. Separator pouch 306 is formed of a separator material and can be placed over cathode material 310 of end cathode 210 or cathode material 314 of anode-cathode 206 to provide separator in the cells that are formed in stack 200. As is illustrated in FIG. 3D, separator pouch 306 may include wall wicks 308. As discussed above, wall wicks 308 can help with aligning components during assembly as well as to wick electrolyte from the sidewalls of a pressure vessel. In some embodiments, separator material can be placed loosely between cathode material of end cathode 210 and anode material 212 of anode-cathode 206, between cathode material 314 of anode-cathode 206 and anode material 212 of anode-cathode 206, or between cathode material 314 of anode-cathode 206 and anode material 302 of end anode 208 to provide separation in the cells that are formed in stack 200 and separator pouch 306 is not formed.

In accordance with embodiments of the present disclosure, the anode material used in end anode 208 and in intermediate anode-cathode 206 are embossed to facilitate the transportation of hydrogen gas between the anode material and outer space. In the case of anodes formed from two sheets of material, the embossed side of the anode material may be positioned facing each other.

The metal-hydrogen battery described above, which is typically a nickel-hydrogen battery, employes a hydrogen electrode as the negative electrode (anode). This hydrogen electrode uses hydrogen gas as its active material and operates by providing active catalytic sites with the gaseous and aqueous species needed for oxidation and reduction of the hydrogen gas. The anode reactions involve three-phase electrocatalytic reactions, which generate hydrogen gas as its product during charge and consume hydrogen gas as its reactant during discharge. The oxidation and reduction process is indicated in the following reaction, which is reversible during charge and discharge.

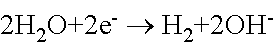

For this reaction to occur reversibly at a high rate during both charge and discharge, the anode active catalytic material of the anode material should be simultaneously maintained in contact with both a hydrogen gas source and a reservoir of alkaline electrolyte. In accordance with embodiments of the present disclosure, to provide the hydrogen gas source, a matrix of gas channels is integrated to the anode material by creating indentations with desired depth and tortuosity, a process referred to as debossing a debossing pattern. This debossing pattern facilitates the efficient flow of hydrogen gas into or out of the catalytic sites in the anode electrode.

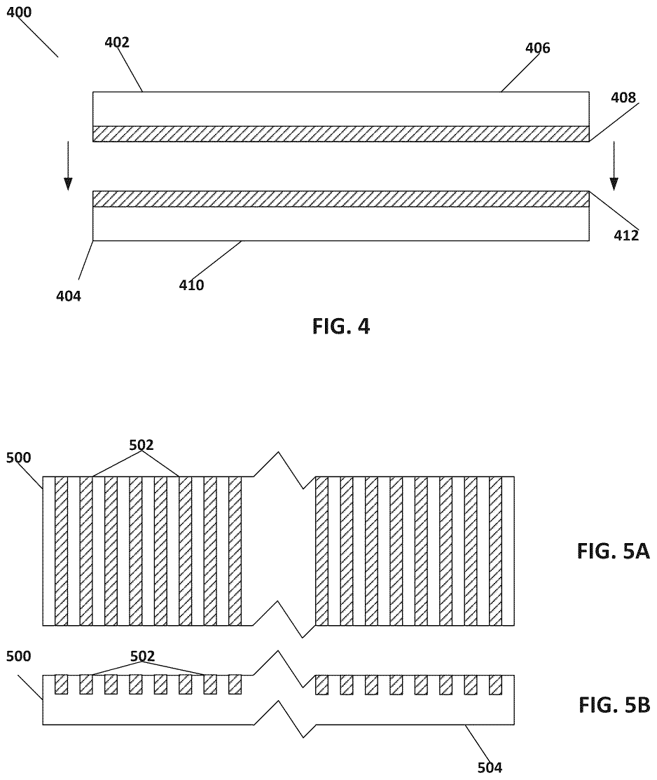

FIG. 4 illustrates a cross-section of an anode structure 400, which may be used in end anode 208 and in intermediate anode-cathode 206, according to some embodiments of the present disclosure. As illustrated in FIG. 4, anode structure 400 is formed of two layers of anode material, first layer of anode material 402 and second layer of anode material 404, which are stacked to form anode structure 400. As shown in FIG. 4, anode material 402 includes a flat side 406 and an embossed side 408. Similarly, anode material 404 includes a flat side 410 and an embossed side 412. Anode material 402 and anode material 404 are stacked embossed side 408 contacting embossed side 412. In some embodiments, embossed side 408 and embossed side 412 can have the same embossing pattern. However, in some embodiments embossed side 408 and embossed side 412 can have differing embossing patterns. The resulting anode material 400 then includes passageways formed by the embossing that allows for transport of hydrogen gas between anode material 402 and anode material 404.

Embodiments of the present disclosure provide various example debossing patterns that can be used in a two-layered anode structure as illustrated in FIG. 4. In some embodiments, the debossing patterns can include any pattern, including a chevron debossing pattern, a corrugation pattern, meshed patterns, an angled pattern (e.g. a 45-degree pattern), or a downweb pattern. The debossing pattern can be created either by pressing a metal mesh into the anode Ni-Foam material using a roller or by directly embossing the roller with patterns then using the roller to deboss the anode.

Some embodiments of the present disclosure have been produced and tested. Embossed anode material that can be used in anode material 402 and 404 can be formed using a nickel-foam material coated with catalyst material. Various parameters of anode materials 402 and 404 have been evaluated, including uniformity, thickness, nesting, and performance.

FIGS. 5A and 5B illustrates an anode material 500, which may be used as anode material 402 or anode material 404 in FIG. 4, with a corrugated debossing pattern 502. As illustrated in FIG. 5A, anode material 500 is imprinted with indents 502 that are laterally imprinted across the short side of anode material 500, leaving a flat side 504. In some cases, these indents can be a few tenths of a millimeter into a roughly 1 mm thick anode material 500. In some particular examples, indents 502 run parallel to the short edge of anode material 500. Anode material 500 can be, for example, 0.8 mm thick and be imprinted with indents of depth roughly 0.15 mm. A problem with such an arrangement is when two layers of anode material 500 are positioned with the indented side 502 together, for example as with anode material 402 and anode material 404 of anode 400 illustrated in FIG. 4, there is a substantial chance that the corrugated debossing pattern 408 of anode material 402 will interfere with and potentially close passages with the corrugated debossing pattern 412 of anode sheet 402 when anode material 400 is assembled using anode material 500 as shown in FIGS. 5A and 5B.

Corrugated patterns have been used in batteries that use three-layer anodes, where the middle layer is corrugated on both sides while the other layers are flat. Several metal-hydrogen vessels operating with the three-layer anodes with corrugated debossing patterns have been tested and the efficiencies have been measured. In particular, using nine (9) vessels as a test sample, after 6 cycles the coulomb efficiency (CE) was 96.5%, the voltage efficiency (VE) was 86.2%, and the Energy Efficiency (EE) was 83.2%. After 20 cycles, CE was 97.9%, VE was 85.9%, and EE was 84.1%.

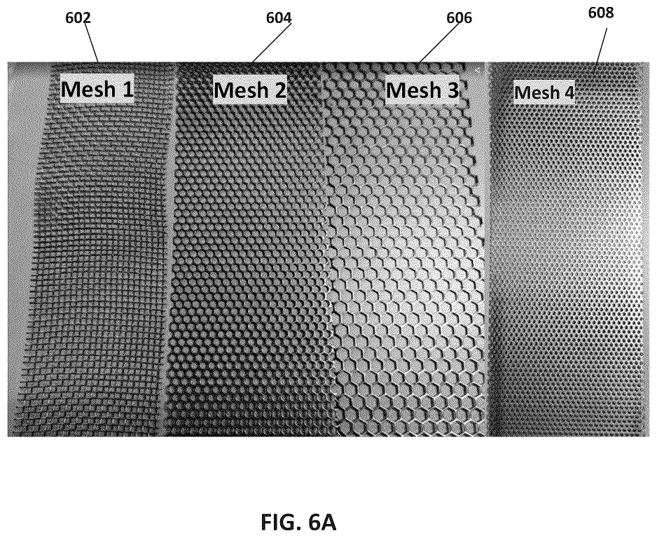

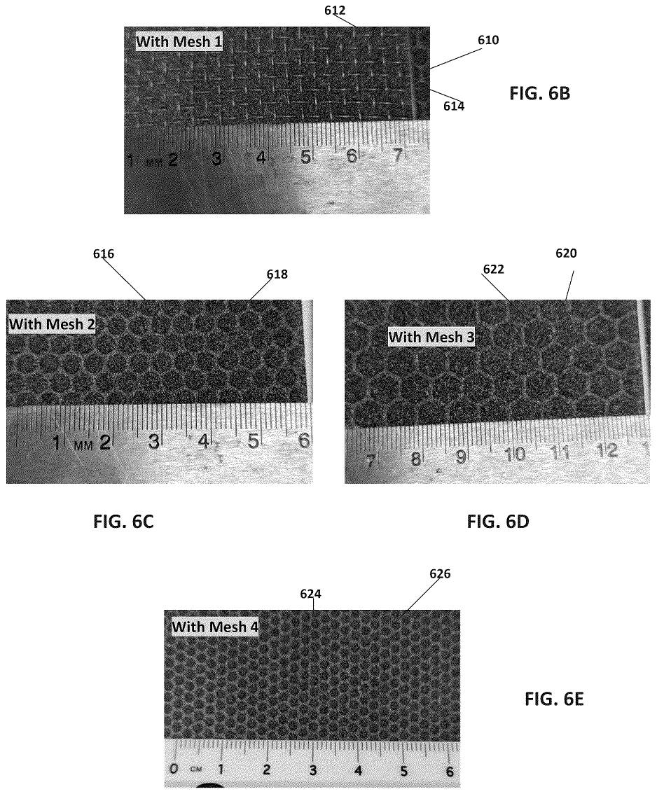

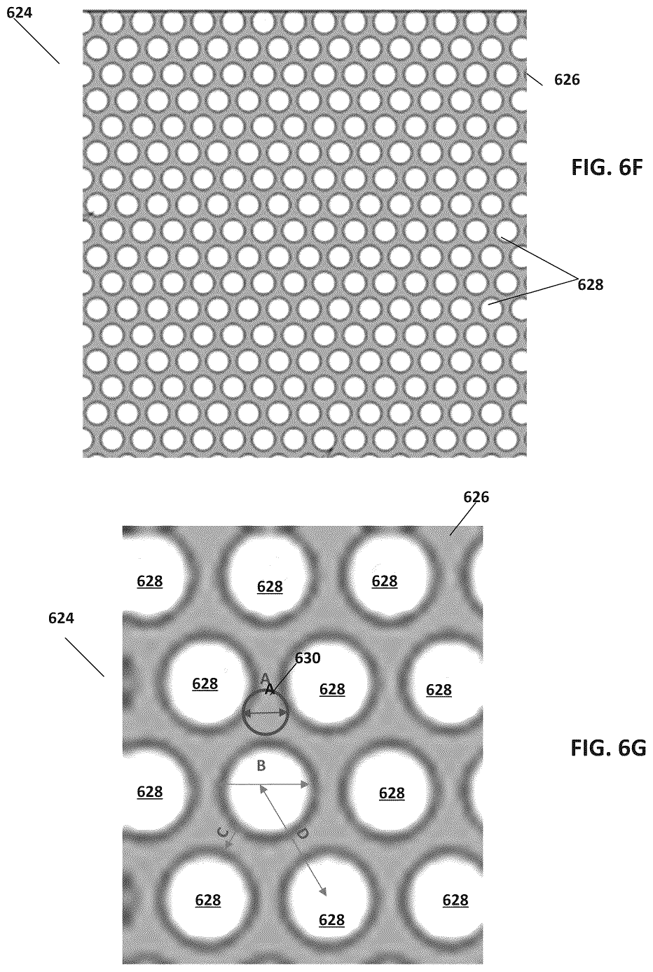

FIGS. 6A through 6G illustrate examples of producing a meshed embossing pattern that can be embossed into anode material. FIG. 6A illustrates four (4) examples of metallic embossing presses with patterns that can be used to press a corresponding embossing pattern into anode material. These metallic presses include a woven mesh press 602 (Mesh 1) and perforated mesh presses 604 (Mesh 2), 606 (Mesh 3), and 608 (Mesh 4).

Woven mesh press 602 (Mesh 1), for example, can be formed of a woven wire matrix. The wire used in the woven wire matrix can be of any size and the spacing between wires in the weave can be of any size. In a particular example, presented here for discussion only, the wire thickness can be 0.028 inches placed in an 8×8 mesh resulting in an opening size of 0.97 inch square. This pattern results in a 60% opening space for the wire mesh press 602. A planar view of an anode material 610 where woven mesh press 602 has been used to provide a debossing layer is illustrated in FIG. 6B. A ruler, in centimeters, is shown placed over anode material 610 to illustrate sizing of debossing indents 612 and 614. In one particular example, a 0.6 mm thick anode material after stamping with woven mesh press 602 can provide indentations of 0.410 mm depth in a direction parallel to the short edge, indents 612, and 0.426 mm depth in a direction parallel to the long edge, indents 614.

Several vessels were tested using anode material 610 formed with woven mesh press 602 (Mesh 1), which was formed into an anode 400 as illustrated in FIG. 4. In particular, 14 separate vessels were tested, with the result that after the 6^{th} cycle the CE was 96.6%, the VE was 85.4%, and the EE was 82.5%. After the 20^{th} cycle, the CE was 97.5%, VE was 85.3%, and EE was 83.2%.

Mesh press 604 (Mesh 2), mesh press 606 (Mesh 3), and mesh press 608 (Mesh 4) form debossing patterns as illustrated in FIGS. 6C, 6D, and 6E, respectively. Mesh press 604, mesh press 606, and mesh press 608 are perforated meshes configured to provide hexagonal indents in anode materials. In some embodiments, circular or other shaped indents can be used. FIG. 6C illustrates anode material 616 with hexagonal indentations 618 formed by mesh press 604. FIG. 6D illustrate anode 620 with hexagonal indentations 622 formed by mesh press 606. FIG. 6E illustrates anode material 624 with indents 626 formed by mesh press 608. In a particular example, mesh press 608 can be 0.76 mm thick, have hole diameter 1.98 mm, and hole center distance 2.77 mm. Several vessels have been formed with anode materials 624 as for Mesh 4. Similar to above, with 6 vessels formed and tested, after 6 cycles CE=96.6%, VE=86.3%, and EE=83.3%. After 20 cycles, CE=97.5%, VE=86.3%, and EE=84.2%.

FIGS. 6F and 6G illustrate the resulting indent pattern corresponding to anode material 624 illustrated in FIG. 6E. FIG. 6G is an expanded version of FIG. 6F. As shown in FIG. 6F, debossing pattern 626 form areas 628 that were not indented when mesh press 608 is pressed onto anode material 624 to form the debossing pattern 626. The debossing pattern in anode material 624 can be characterized with parameters A, B, C, and D. The parameter A is the diameter of a circle 630 formed such that it intersects three adjoining un-indented areas 628. The parameter B is the diameter of un-indented area 628. The parameter C is the minimum thickness of the indentation 626 between two adjacent un-indented areas 628. The parameter D is the distance from the center of an un-indented area 628 and the center of its nearest neighbor un-indented area 628.

In a particular example, mesh press 608 can be 0.76 mm thick, have a hole diameter 1.98 mm, and hole center distance 2.77 mm. As discussed above, after pressing, the parameters of embossing pattern for anode material 624 can be A=1.22 mm, B=1.98 mm, C=0.79 mm, and D=2.77 mm. In some embodiments, mesh press 604 produces anode material 616 with an embossing pattern with parameters A=1.53 mm, B=3.982 mm, C=0.79 mm, and D=4.775 mm.

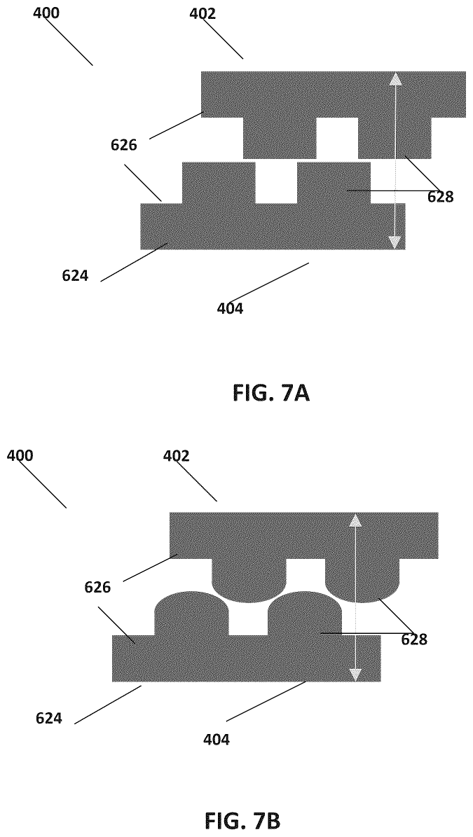

A particular issue with mesh type debossing patterns is nesting, which occurs when debossing patterns 408 and 412 effectively interfere with one another when anode 400 is formed. Nesting is illustrated in FIGS. 7A and 7B. When anode 400 is formed by positioning debossing pattern 408 of anode material 402 against debossing pattern 412 of anode material 404, where anode material 402 and 404 are formed of anode material 624 with debossing pattern 626 as illustrated in FIGS. 6A through 6F, then there is a significant probability that those patterns will nest against one another and thereby reduce the size of passageways that create the flow of hydrogen gas.

FIG. 7A illustrates anode 400 with anode material 402 positioned over anode material 404, where anode material 402 and anode material 404 are anode material 624 as discussed above. As shown in FIG. 7A, in an ideal situation, un-indented areas 628 connect and do not block the passageways formed by indents 626. FIG. 7B, however, illustrates the less ideal case where un-indented areas 628 are not flat, but rather are rounded due to the non-ideal pressing process.

Using the defining parameters A and B as defined above, a difference ratio defined by (B−A)/B can help determine the chance of nesting with a particular debossing pattern. Using the examples above, for example, analog material 624 results in a ratio of 38% while the ratio for analog material 616 is 62%. The higher the difference ratio, the lower the chance of nesting. The nesting parameter can be defined, in a two-layer anode, referring to FIG. 4, as

$$Nesting factor = ( ( X + Y ) - Z ) / Z ,$$

X=thickness of anode material 402,
Y=thickness of anode material 404, and
Z=measured thickness of anode 400. The resulting nesting factors, as is shown for various debossing patterns in Table III below, can be expressed as a percentage.

As discussed above, three-level anodes with a corrugated debossing pattern and two mesh patterns, the woven mesh pattern illustrated by anode material 612 and perforated mesh pattern illustrated by anode material 624 above, were tested. Table I below summarizes the efficiencies recorded for these and other test results. As is observed, the overall performance of anode material 624, the perforated mesh, provides overall better performance. However, as also indicated above, mesh patterns may suffer from nesting problems.

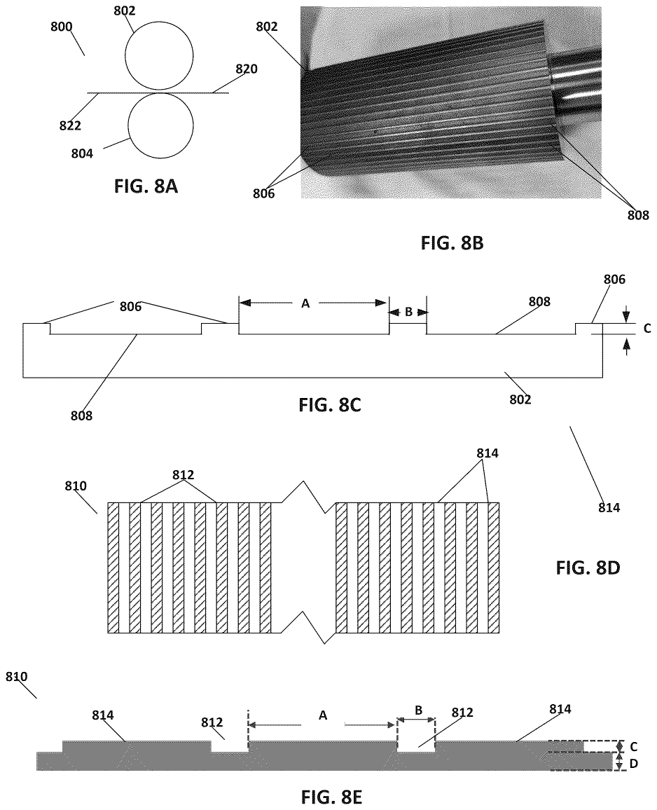

FIGS. 8A through 8E illustrate production of an anode material 810 that has a down-web debossing pattern. FIG. 8A illustrates a roller press 800 that includes a top roller 802 having a down-web debossing pattern and a bottom roller 804 with a smooth surface. As shown in FIG. 8A, an analog material 822 passed between top roller 802 and bottom roller 804 to produce an analog material 820 with an embossed region (such as embossed region 408 and 412 shown in FIG. 4) opposite a smooth surface (such as surfaces 406 and 410 as shown in FIG. 4).

FIG. 8B illustrates an example of top roller 802. As shown in FIG. 8B, top roller 802 includes ridges 806 and valleys 808. FIG. 8C illustrates a cross section of top roller 802 that shows ridges 806 and valleys 808. As is indicated, in some embodiments ridges 806 are a rectangular protrusion from the floor of valleys 808. The pattern can be characterized by valleys 808 having a width A, ridges 806 having a width B, and the height of ridges 806 from the floor of valleys 808 is C.

FIG. 8D illustrates an anode material 810 cut to serve as anode material 402 or anode material 404 as illustrated in FIG. 4. As illustrated in FIG. 8D, processed anode material 820 is cut appropriately to form anode 400. FIG. 8D illustrates a planar view of anode material 810 and shows indents 812 and protrusions 814, which are formed by ridges 806 and valleys 808 respectively. As shown in FIG. 8E, protrusions 814 have width A, indents 812 have width B and are of a depth C. The depth D is the remaining depth of anode material 810 below the bottom of indent 812. As shown in FIG. 8D, trenches 812 are formed in anode material 810 in a direction parallel to the short side of anode material 810.

Several samples of anode material 810 have been produced using the example nominal parameters A=3 mm, B=0.8 mm, C=0.25 mm, and D=0.25 mm. Batteries were formed from the resulting anodes. Although the overall thickness was satisfactory, there was a wide distribution of the depth C of across anode material, with values for C ranging, for example, from 0.1 to 0.3 mm. However, as shown in Table I below, the efficiency analysis initiates CE=97.0%, EE=82.9%, and VE=85.5% after 6 cycles and CE=97.7%, EE=84.3%, and VE=86.3% after 20 cycles. It should also be noted that nesting may be a problem with the downweb debossing pattern.

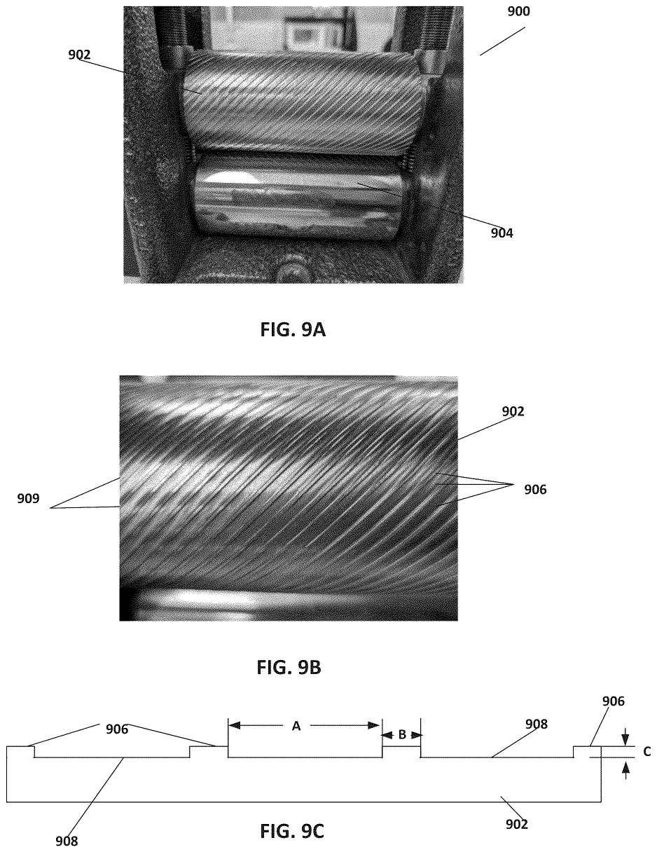

Another debossing pattern is an angled pattern, for example a 45-degree pattern. FIGS. 9A through 9C illustrate a roller press 900 that can be used to provide an angled debossing pattern to anode material. Figures and 10A through 10D illustrate an angled debossing pattern on anode material.

As illustrated in FIG. 9A, roller press 900 includes a top roller 902 with an embossing pattern and a bottom roller 904 that is smooth. An anode material that is processed through roller press 900 will then, as illustrated in FIG. 4, have a flat side, which may be side 406 and 410 as illustrated in FIG. 4, and an embossed region, which may be embossed portion 408 and 412 illustrated in FIG. 4. FIG. 9B further illustrates the embossing pattern on top roller 902. As illustrated, the embossing pattern includes ridges 906 and valleys 908 positioned so that, as an anode material is processed, imprints an angular debossing pattern onto the anode material. FIG. 9C illustrates a cross-sectional view across top roller 902, illustrating the pattern. As illustrated in FIG. 9C, ridges 906 and valleys 908. In many cases, ridges 906 can be square protrusions extending from valleys 908 by a height C. Further, ridges 906 may be of width B and valleys 908 can have a width A. Although the values of A, B, and C can be any value, the relationship between A and B can be any value, and many embodiments are arranged to minimize the probability of nesting between embossed region 408 and embossed region 412 in anode 400.

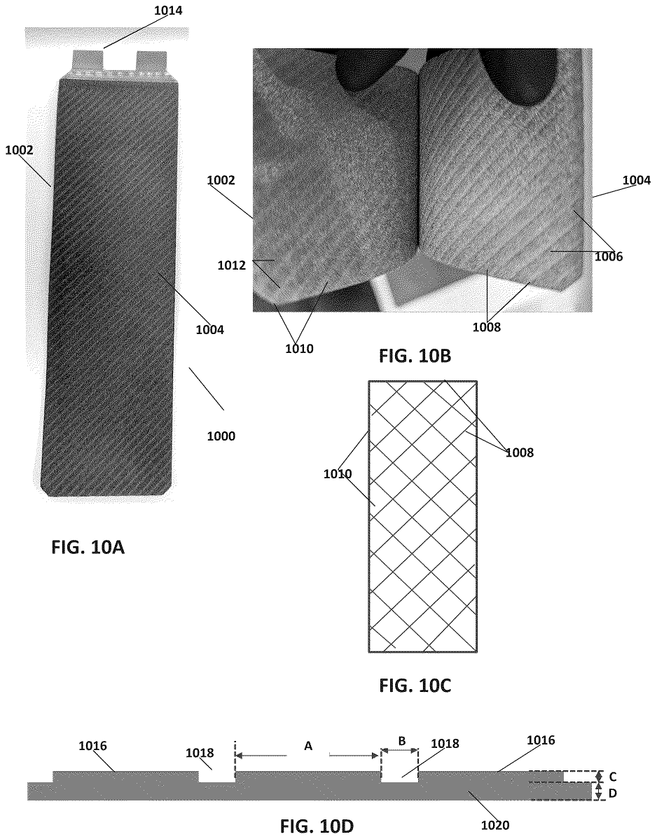

FIGS. 10A, 10B, 10C, and 10D illustrate an anode and anode materials. FIGS. 10A and 10B illustrate an anode 1000 having two anode materials 1002 and 1004 that include an angle embossing formed in roller press 900 illustrated in FIGS. 9A through 9C. FIG. 10A illustrates a planar view of anode 1000, which includes analog material 1002 stacked on analog material 1004 and welded to tabs 1014. FIG. 10B illustrates views of analog material 1002 and analog material 1004 of anode 1000. As illustrated, analog material 1002 is embossed with an angled embossing pattern having ridges 1012 and grooves 1010. Similarly, analog material 1004 is embossed with an angled embossing pattern having ridges 1006 and grooves 1008. As illustrated in FIG. 10C, anode 1000 arranges anode material 1002 and 1004 so that ridges 1008 and 1010 form a crossing pattern, which reduces the probability of nesting.

FIG. 10D illustrates a cross-section of an anode material 1020 with angled embossing pattern as discussed above. As illustrated in FIG. 10D, anode material 1020 includes ridges 1016 and indents 1018. Indents 1018 are formed in roller press 900 by ridges 906 while indents 1018 are formed by valleys 908. As illustrated, indents 1018 have a width B while ridges 1016 have a width A. Indents 1018 have a depth C while the thickness between the bottom of indent 1018 and the flat bottom of anode material 1020 is D. Anode material 1020 reflects either anode material 1002 or anode material 1004.

For a particular example, the nominal values can be A=3 mm, B=0.8 mm, C=0.25 mm, and D=0.25 mm. The specification for the overall thickness of anode material 1020 can be 0.52 mm+/−0.08 mm. Measurements of several samples of anode material 1020 resulted in an actual measurement of 0.516 mm. Similar measurements with analog material 616 (Mesh 2) or analog material 624 (Mesh 4) as described above resulted in thicknesses of 0.57 to 0.58 mm, which falls outside of the desired specification. Actual measurements of anode material 1020 can, for example, result in a debossing height C=0.27 mm, ridge width A=3.1 mm, indent width of 0.6 mm, resulting in an actual difference ratio of 80.6%. This may result in a low nesting factor of 1.6-2.2%. Table I below indicates the efficiencies of various samples of anode material 920 where the angled debossing is at 45-degrees in comparison with several samples of anode material 616 (Mesh 2) as described above. As is illustrated, the performance of anode material 1020 is similar to that of anode material 616. Further, the performance is the same as the down-web debossing pattern of anode material 810 as illustrated in FIGS. 8A through 8E.

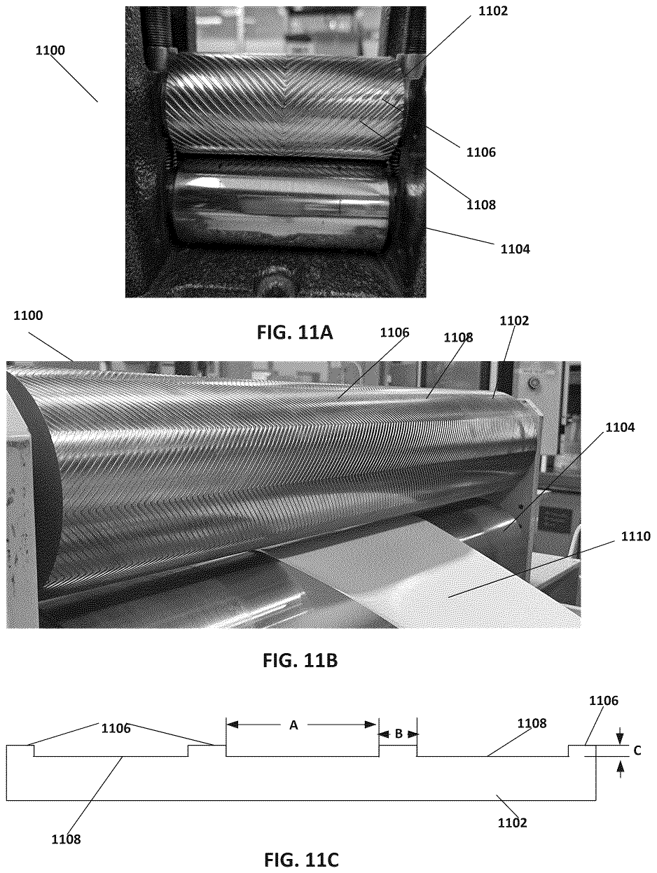

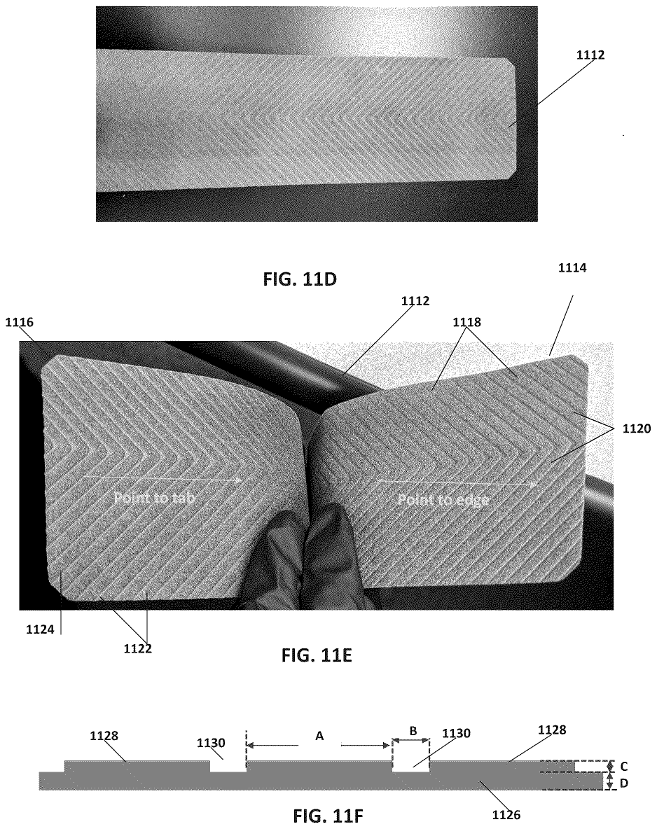

FIGS. 11A through 11F illustrate formation of an anode material 1112 where a chevron debossing pattern is imprinted. FIG. 11A illustrates a roller press 1100. As shown, roller press 1100 includes a top roller 1102 and a bottom roller 1104. As illustrates, top roller 1102 includes ridges 1106 and valleys 1108 shaped in a chevron pattern. As before, bottom roller 1104 is smooth so that, when anode material is processed through roller press 1100, a chevron debossing pattern is imprinted into the anode material. FIG. 11B, illustrates another example of roller press 1100, where the chevron pattern having ridges 1106 and valleys 1108 is oriented along a length of top roller 1102 rather than along the rotational direction of top roller 1102. As illustrated in FIG. 11B, an anode material 1110 can be processed through roller press 1100 to produce an anode material with a chevron debossing pattern. FIG. 11C shows a cross-section cut of top roller 1102 as illustrated in either of FIG. 11A or 11B. As discussed above, top roller 1102 has ridges 1106 and valleys 1108. Valleys 1108 have a width A while ridges 1106 have a width B. The depth of ridges 1106 is C.

FIG. 111D shows an example anode 1112 formed with a chevron debossing pattern. As is shown in FIG. 4 and in FIGS. 3A through 3D, anode 1112 includes a tab or a binder (not shown) and includes two layers. FIG. 11E illustrates two layers of anode material, anode material 1114 and anode material 1116, which are combined to form anode 1112, which can be the anode 400 illustrated in FIG. 4. As shown in FIG. 11E, analog material 1114 includes ridges 1118 and indents 1120 that are shaped in a chevron pattern that is pointed towards the free edge. Analog material 1116 similarly includes ridges 1122 and indents 1124 in a chevron pattern that is pointed towards the tab, where analog material 1114 and analog material 1116 are welded as described above. As a combination, when anode material 114 and anode material 116 are stacked as illustrated in FIG. 4, nesting is reduced.

FIG. 11F illustrates a cross section of anode material 1126, which may be one of anode material 1114 or anode material 1116 as illustrated in FIG. 11E. As shown in FIG. 11F, the chevron pattern includes protrusions 1128 and indents 1130, which are formed by ridges 1106 and valleys 1108 as shown in FIG. 11C. As discussed above, protrusions 1128 have a width A, indents 1130 have a width 1130 and are a depth C. The thickness of anode material 1125 from the bottom of indents 1130 is thickness D.

In some examples, which have been used in testing, nominal values for A=3 mm, B=0.8 mm, C=0.25 mm, and D=0.25 mm. In some particular examples, the tolerance on these values can be +/−10%. In measured results of anode material 1126, the debossing depth is between 0.24 to about 0.26 mm, width A can be 2.89 mm, the depth C is about 0.86 mm, which can fall within the desired specifications for such parameters. The starting 2 L anode thickness can be, for example, 0.88 to 1.2 mm, with a two-layer thickness of up to 1.04 mm with a tolerance of 15%. Measurements of the debossing depths C for both sides of the chevron proved to be relatively uniform and within the desired specification.

Measurements of the nesting factor for the above defined chevron debossing pattern with measurements taken from a POR debossing pattern indicate that the nesting factor for the chevron debossing pattern is 2% while the nesting factor for the POS debossing pattern is 10.9%. Table I provides performance results for various examples of the chevron debossing pattern as illustrated in FIGS. 11A-11F. As illustrated, the chevron debossing pattern performs well and exhibits lower nesting results than the POR debossing patterns and is similar to the angled debossing pattern discussed above. The charge/discharge cycle illustrated in Table I is with a C-rate of C/2. Comparisons of C/1.6 and C/2 performance between the chevron debossing pattern and the downweb debossing pattern is illustrated in Table 2. As shown, both debossing patterns perform well.

TABLE I

Duration
After 20 cycles

| Debossing Pattern | CE % | VE % | EE % |
|---|---|---|---|
| Corrugated | 97.9 | 85.9 | 84.1 |
| Woven Mesh | 97.5 | 85.3 | 83.2 |
| Perforated Mesh (Mesh 4) | 97.5 | 86.3 | 84.2 |
| Mesh 2 - Sample 1 | 97.1 | 85.8 | 83.3 |
| Mesh 2 - Sample 2 | 97.1 | 86.0 | 83.5 |
| Down-web | 87.7 | 86.3 | 84.3 |
| Angled (45-degree) - | 97.0 | 85.7 | 83.1 |
| Sample 1 | | | |
| Angled (45-degree) - | 97.0 | 86.1 | 83.5 |
| Sample 2 | | | |
| Angled (45-degree) - | 97.0 | 86.1 | 83.5 |
| Sample 3 | | | |
| Angled (45-degree) - | 97.8 | 86.7 | 84.8 |
| Sample 4 | | | |
| Chevron - Sample 1 | 97.8 | 86.3 | 84.4 |
| Chevron -- Sample 2 | 96.6 | 86.4 | 83.4 |
| Chevron - Sample 3 | 97.8 | 86.6 | 84.7 |
| Chevron - Sample 4 | 97.9 | 86.6 | 84.7 |
| Chevron - Sample 5 | 97.7 | 86.7 | 84.7 |

TABLE II

| | | | 300^{th} | 300^{th} | 300^{th} |
|---|---|---|---|---|---|
| Stack ID | Debossing | C rate | CE | EE | VE |
| IPVE-chevron_1 | Chevron | C/1.6 | 98.4 | 83.1 | 84.5 |
| IPVE-downweb_1 | Downweb | | 98.4 | 83.0 | 84.3 |
| IPVE-chevron_2 | Chevron | C/2 | 98.4 | 84.8 | 86.2 |
| IPVE-downweb_2 | Downweb | | 98.2 | 84.6 | 86.1 |

TABLE III

| Deboss type | Nesting factor (%) |
|---|---|
| Mesh2 | 4.6 |
| Mesh4 | 10.9 |
| 45 deg deboss | 2.2 |
| Chevron deboss | 2.0 |

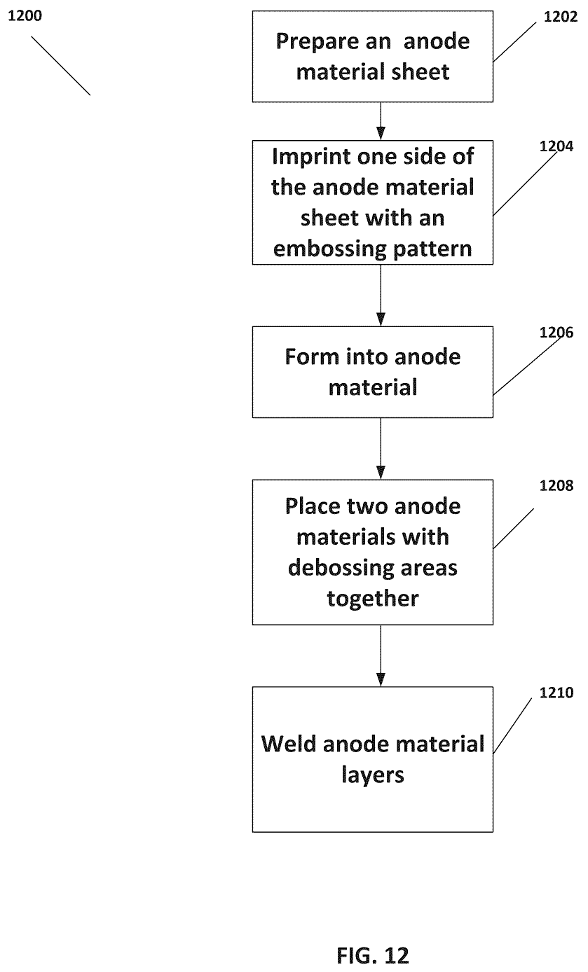

FIG. 12 illustrates a method 1200 of performing an anode such as anode 400 according to embodiments of the present disclosure. As illustrated in FIG. 12, method 1200 begins at step 1202. In step 1202, an anode material sheet is obtained. As discussed above, the anode material sheet can be an anode material that is coated with a catalyst material or other materials. The thickness of the anode material can be appropriately chosen. In some embodiments, the thickness of the anode material, which can be formed of Nickel foam, can be about 0.820 mm. In step 1204, the anode material is imprinted with a debossing pattern and compressed to a specified thickness. As discussed above, step 1204 may include pressing with an embossing press having the embossing patterns as illustrated in FIGS. 6A through 6G and in FIGS. 7A through 7B or by roller pressing as is illustrated in FIGS. 8A through 8E, FIGS. 9A through 9C, FIGS. 10A through 10D, or FIGS. 11A through 11F. During the imprint process, anode material may also be compressed to an appropriate thickness. In some embodiments, the imprinting is performed such that the thickness of the anode material matches the desired thickness of an anode material (in the examples discussed above, about 0.50 mm) while the imprint depth (C) remains at the nominal desired value (in the examples discussed above, about 0.25 mm).

In step 1206, the imprinted anode material is cut into the final dimensions of an anode material 402 or anode material 404 as illustrated in FIG. 4. In step 1208, two layers of anode material, anode material 402 and anode material 404, are stacked such that the debossing patterns are together. Finally, in step 1210, the two layers are welded. In some cases, as illustrated in FIGS. 3A through 3D, the two layers are welded to a tab 222 or, as illustrated in FIG. 3C, the are welded to a connector 216.

In the example of a chevron roller 1100 as illustrated in FIG. 11A, variations can occur across the width and length of the resulting anode material. In particular, the thickness may exhibit bowing in both directions, with thicknesses near the edges less than thickness in the central regions. Cutting the anode material to size prior to embossing through the roller press may help reduce thickness variations across the resulting analog material. However, as is discussed above and illustrated in Tables 1, 2, and 3, the performance of analog materials with the embossed patterns is well within the desired metrics.

Some aspects of embodiments of the current disclosure are listed below. These aspects are exemplary.
Aspect 1: An anode, comprising: a first anode material, the first anode material having a flat side and an embossed side that is embossed with a first embossing pattern; and a second anode material, the second anode material having a flat side and an embossed side that is embossed with a second embossing pattern, wherein the embossed side of the first anode material is positioned against the embossed side of the second anode material, and wherein the first anode material and the second anode material are coupled on one edge.
Aspect 2: The anode of Aspect 1, wherein the first embossing pattern and the second embossing pattern are each a mesh pattern.
Aspect 3: The anode of any of Aspects 1 or 2, wherein the first embossing pattern and the second embossing pattern are formed with a press.
Aspect 4: The anode of any of Aspects 1 or 2, wherein the press includes a wire mesh.
Aspect 5: The anode of any of Aspects 1 or 2, wherein the press includes a perforated metallic pattern.
Aspect 6: The anode of Aspect 1, wherein the first embossing pattern and the second embossing pattern are formed with a roller press.
Aspect 7: The anode of any of Aspects 1 or 6, wherein the roller press includes a first roller with an embossing pattern and a second roller with a smooth surface.
Aspect 8: The anode of any of Aspects 1, 6, or 7, wherein the embossing pattern is a downweb pattern.
Aspect 9: The anode of any of Aspects 1, 6, or 7, wherein the embossing pattern is an angular pattern.
Aspect 10: The anode of any of Aspects 1, 6, 7, or 9, wherein the angular pattern is a 45-degree pattern.
Aspect 11: The anode of any of Aspects 1, 6, 7, or 9, wherein the first anode material and the second anode material are stacked such that the angular pattern of the first embossing pattern and the angular pattern of the second embossing pattern are crossed.
Aspect 12: The anode material of any of Aspects 1, 6, or 7, wherein the embossing pattern is a chevron pattern.
Aspect 13: The anode material of any of Aspects 1, 6, 7, or 12, wherein the first anode material and the second anode material are stacked such that the chevron pattern of the first embossing pattern points to a first edge and the chevron pattern of the second embossing pattern points to the edge opposite the first edge.
Aspect 14: The anode material of any of Aspects 1 through 13, wherein the edge is a tab.
Aspect 15: The anode material of any of Aspects 1 through 13, wherein the edge is a metal sheet.
Aspect 16: A method of forming an anode, comprising: preparing an anode material sheet; imprinting an embossing pattern on the anode material sheet; forming anode material from the embossed anode material sheet; placing two anode materials together with the embossing pattern of each of the anode materials facing each other; and welding the two anode materials together along one edge.
Aspect 17: The method of Aspect 16, wherein the anode material includes a Ni-Foam coated with a catalyst.
Aspect 18: The method of any of Aspects 16 or 17, wherein imprinting the embossing pattern includes pressing the embossing pattern with a press into the anode material sheet.
Aspect 19: The method of any of Aspects 16 through 18, wherein the press is a wire mesh.
Aspect 20: The method of any of Aspects 16 through 18, wherein the press is a protrusion mesh.
Aspect 21: The method of any of Aspects 16 or 17, wherein imprinting the embossing pattern includes placing the anode material sheet through a rolling press with an embossing pattern.
Aspect 22: The method of any of Aspects 16, 17, or 21, wherein the embossing pattern is a down-web pattern.
Aspects 23: The method of any of Aspects 16, 17, or 21, wherein the embossing pattern is an angled pattern.
Aspect 24: The method of any of Aspects 16, 17, or 21, wherein the embossing pattern is a chevron pattern.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the disclosure be defined by the following claims and their equivalence.

What is claimed is:

1. An anode, comprising:
a first anode material, the first anode material having a flat side and an embossed side that is embossed with a first embossing pattern; and
a second anode material, the second anode material having a flat side and an embossed side that is embossed with a second embossing pattern,
wherein the embossed side of the first anode material is positioned against the embossed side of the second anode material, and
wherein the first anode material and the second anode material are coupled on one edge.

2. The anode of claim 1, wherein the first embossing pattern and the second embossing pattern are each a mesh pattern.

3. The anode of claim 2, wherein the first embossing pattern and the second embossing pattern are formed with a press.

4. The anode of claim 3, wherein the press includes a wire mesh.

5. The anode of claim 3, wherein the press includes a perforated metallic pattern.

6. The anode of claim 1, wherein the first embossing pattern and the second embossing pattern are formed with a roller press.

7. The anode of claim 6, wherein the roller press includes a first roller with an embossing pattern and a second roller with a smooth surface.

8. The anode of claim 7, wherein the embossing pattern is a downweb pattern.

9. The anode of claim 7, wherein the embossing pattern is an angular pattern.

10. The anode of claim 9, wherein the angular pattern is a 45-degree pattern.

11. The anode of claim 7, wherein the first anode material and the second anode material are stacked such that the angular pattern of the first embossing pattern and the angular pattern of the second embossing pattern are crossed.

12. The anode material of claim 7, wherein the embossing pattern is a chevron pattern.

13. The anode material of claim 12, wherein the first anode material and the second anode material are stacked such that the chevron pattern of the first embossing pattern points to a first edge and the chevron pattern of the second embossing pattern points to the edge opposite the first edge.

14. The anode material of claim 1, wherein the edge is a tab.

15. The anode material of claim 1, wherein the edge is a metal sheet.

16. A method of forming an anode, comprising:
preparing an anode material sheet;
imprinting an embossing pattern on the anode material sheet;
forming anode material from the embossed anode material sheet;
placing two anode materials together with the embossing pattern of each of the anode materials facing each other; and
welding the two anode materials together along one edge.

17. The method of claim 16, wherein the anode material includes a Ni-Foam coated with a catalyst.

18. The method of claim 16, wherein imprinting the embossing pattern includes pressing the embossing pattern with a press into the anode material sheet.

19. The method of claim 18, wherein the press is a wire mesh.

20. The method of claim 18, wherein the press is a protrusion mesh.

21. The method of claim 16, wherein imprinting the embossing pattern includes placing the anode material sheet through a rolling press with an embossing pattern.

22. The method of claim 21, wherein the embossing pattern is a down-web pattern.

23. The method of claim 21, wherein the embossing pattern is an angled pattern.

24. The method of claim 21, wherein the embossing pattern is a chevron pattern.
